(19) United States
(12) Patent Application Publication
(10) Pub. No.: US 2014/0129300 A1
(43) Pub. Date: May 8, 2014

(54) SYSTEM, METHOD AND COMPUTER PROGRAM PRODUCT FOR PROVIDING A WEBSITE INTRODUCING ORGANIZED, GAINFUL COMPETITION INTO SHARED ELECTRONIC MEDIA

(71) Applicant: SEEUSWIN.COM, LLC, Fairfax, VA (US)

(72) Inventor: Darrel A. Ensor, Pasadena, MD (US)

(73) Assignee: SEEUSWIN.COM, LLC, Fairfax, VA (US)

(21) Appl. No.: 13/973,797

(22) Filed: Aug. 22, 2013

Related U.S. Application Data
(60) Provisional application No. 61/692,002, filed on Aug. 22, 2012.

(51) Int. Cl. G06Q 30/02

(52) U.S. Cl. CPC G06Q 30/0239
USPC 705/12; 705/14.39

(57) ABSTRACT

A method for providing rewards includes receiving a media content item from a first user and providing the media content item to a second user. The method further includes receiving input from the second user in accordance with a first set of predetermined rules associated with the second user. The method also includes providing a reward to the first user in accordance with a second set of predetermined rules associated with the media content item.

### REFERENCE TO RELATED APPLICATIONS

This application claims the benefit of U.S. Provisional Patent Application No. 61/692,002, filed on Aug. 22, 2012, the entire contents of which are incorporated herein by reference.

### TECHNICAL FIELD

The present invention relates, generally, to a system, method and computer program product for providing a website introducing organized, gainful competition into shared electronic media. Embodiments of the present invention are directed to a system, method and computer program product for providing a website enabling users to compete by sharing electronic media items, voting on electronic media items, and achieving a ranking based on the completion of certain pre-selected criteria.

### BACKGROUND

The number of websites that provide electronic media items to networked computer users has increased significantly in recent years. Providers of such electronic media items include video/audio sources, photography sources, audio recording sources, blogs, news sources, businesses, and social networking sources. These electronic media content sources frequently provide new and changed items regularly. Sources that provide electronic media items are frequently passive in the sense that content is uploaded to a website and viewed by users. While users may be able to provide comments on the content or indicate that they like or dislike the content, the interactivity with the electronic media items is limited. There is a need for an active website that provides electronic media items to networked computer users with many options for interactivity.

It is an object of the present invention to overcome disadvantages of the prior art through an active website that introduces organized, gainful competition into shared electronic media items, particularly among popular and/or “viral” (i.e., widely shared) content and themes.

Having competition, as hereinafter described, will qualify the website of the system, method and computer program product of the present invention as active in terms of interaction between the site/archive and users and electronic media items. More specifically, the site will not simply host and record electronic media items but will react to user content, user input and other input, in order to create a platform for interaction, specifically gainful competition.

### SUMMARY

Particular embodiments of the present invention include systems, methods and computer program products for providing a website introducing organized, gainful competition in the area of electronic media items. Embodiments of the invention utilize an “economy” or “sense of an economy” to promote competition. Users of the present invention can collect, earn, and spend votes on certain electronic media items. Additionally, users can achieve a ranking based on the accomplishment of certain, pre-selected criteria.

Embodiments of the present invention include systems, methods and computer program products for providing a website with a plurality of electronic media items comprising a first electronic media item, means for storing the first electronic media item, a second electronic media item, means for storing the second electronic media item, means for displaying the first and second electronic media items, a user input means for enabling a user to vote on the first or second electronic media items, and a means for storing the user input.

Embodiments of the present invention include systems, methods and computer program products for generating and hosting a website with a plurality of electronic media items. The method includes receiving a first electronic media item of a plurality of electronic media items, storing the first electronic media item, receiving a second electronic media item of a plurality of electronic media items, storing the second electronic media item, providing a means for displaying the first and second electronic media items, receiving a user input including a vote for the first or second electronic media item, and storing the user input.

Embodiments of the present invention further include a system including one or more processors, one or more output devices, such as a display unit, one or more input devices, such as a keyboard or mouse, one or more transmitting devices, one or more receiving devices, and one or more storage devices, such as a memory unit. The processer is configured to receive a first electronic media item and a second electronic media item, and further configured to receive a user input including a vote for the first or second electronic media item. The display unit is configured to display the first and second electronic media item. The memory unit is configured to store the first and second electronic media items, and further configured to store the user input including a vote for the first or second electronic media item.

According to some exemplary embodiments, a method for providing rewards includes receiving a media content item from a first user and providing the media content item to a second user. The method further includes receiving input from the second user in accordance with a first set of predetermined rules associated with the second user. The method also includes providing a reward to the first user in accordance with a second set of predetermined rules associated with the media content item.

In some exemplary embodiments, a method implemented by a client device for submitting content and receiving rewards includes submitting a first media content item to one or more servers and receiving a second media content item from the one or more servers. The method further includes providing input for the second media content item in accordance with a first set of predetermined rules. The method also includes receiving a reward for the first media content item in accordance with a second set of predetermined rules.

In exemplary embodiments, the receiving the second media content item includes receiving a web page that is displayed on the client device, the web page including a voting option associated with the second media content item, and the input for the second media content item is a selection of the voting option.

In exemplary embodiments, the first set of predetermined rules specifies a number of remaining votes, and the selection of the voting option is prohibited upon determination that the number of remaining votes is zero.

In exemplary embodiments, the number of remaining votes is decremented upon determination that the number of remaining votes is greater than zero and the voting option is selected.

In exemplary embodiments, the number of remaining votes is incremented upon submission of the first media content item or submission of a completed survey to the one or more servers.

In exemplary embodiments, the second set of predetermined rules specify that the reward for the first media content item is received upon determination that, at an expiration of a predetermined period of time, a vote total associated with the first media content item is higher than a vote total of at least a third media content item.

In exemplary embodiments, the media content item and the third media content item belong to a same predetermined category.

In exemplary embodiments, the first and second media content items are one of a picture, video, or audio file.

According to some exemplary embodiments, a system includes one or more servers. Each of the one or more servers includes a processor, a memory coupled to the processor, and a network interface coupled to the processor. The one or more of the processors is configured to receive a media content item from a first user and provide the media content item to a second user. The one or more of the processors is further configured to receive input from the second user in accordance with a first set of predetermined rules associated with the second user. The one or more of the processors is also configured to provide a reward to the first user in accordance with a second set of predetermined rules associated with the media content item.

According to some exemplary embodiments, a client device for submitting content and receiving rewards includes a processor, a memory coupled to the processor, and a network interface coupled to the processor. The processor is configured to submit a first media content item to one or more servers and receive a second media content item from the one or more servers. The processor is further configured to provide input for the second media content item in accordance with a first set of predetermined rules. The processor is also configured to receive a reward for the first media content item in accordance with a second set of predetermined rules.

In exemplary embodiments, the processor is further configured to receive the second media content item as a web page that is displayed on the client device, the web page including a voting option associated with the second media content item, and the input for the second media content item is a selection of the voting option.

In exemplary embodiments, the first set of predetermined rules specifies a number of remaining votes, and the selection of the voting option is prohibited upon determination that the number of remaining votes is zero.

In exemplary embodiments, the number of remaining votes is decremented upon determination that the number of remaining votes is greater than zero and the voting option is selected.

In exemplary embodiments, the number of remaining votes is incremented upon submission of the first media content item or submission of a completed survey to the one or more servers.

In exemplary embodiments, the second set of predetermined rules specify that the reward for the first media content item is received upon determination that, at an expiration of a predetermined period of time, a vote total associated with the first media content item is higher than a vote total of at least a third media content item.

In exemplary embodiments, the media content item and the third media content item belong to a same predetermined category.

In exemplary embodiments, the first and second media content items are one of a picture, video, or audio file.

According to some exemplary embodiments, a non-transitory computer readable medium having instructions stored therein, which when executed by a processor in a system for providing rewards, causes the processor to execute a method that includes receiving a media content item from a first user and providing the media content item to a second user. The method further includes receiving input from the second user in accordance with a first set of predetermined rules associated with the second user. The method also includes providing a reward to the first user in accordance with a second set of predetermined rules associated with the media content item.

In exemplary embodiments, the first set of predetermined rules indicates that the second user has a number of remaining votes, and the selection of the voting option by the second user is prohibited upon determination that the number of remaining votes is zero.

In exemplary embodiments, the method associated with the non-transitory computer readable medium further includes decrementing the number of remaining votes of the second user upon determination that the number of remaining votes is greater than zero and the second user selected the voting option.

In exemplary embodiments, the method associated with the non-transitory computer readable medium further includes incrementing the number of remaining votes of the second user by a predetermined amount upon determination that one or more media content a completed survey was received from the second user.

In exemplary embodiments, the method associated with the non-transitory computer readable medium further includes incrementing a vote total associated with the media content upon selection of the voting option by the second user.

In exemplary embodiments, the second set of predetermined rules specify that the first user is provided the reward upon determination that, at an expiration of a predetermined period of time, a vote total associated with the media content item is higher than a vote total of at least another media content item.

In exemplary embodiments, the media content item and the another media content item belong to a same predetermined category.

In exemplary embodiments, the media content item is one of a picture, video, or audio file.

According to some exemplary embodiments, a non-transitory computer readable medium having instructions stored therein, which when executed by a processor in a client device for submitting content and receiving rewards, causes the processor to execute a method that includes submitting a first media content item to one or more servers and receiving a second media content item from the one or more servers. The method further includes providing input for the second media content item in accordance with a first set of predetermined rules. The method also includes receiving a reward for the first media content item in accordance with a second set of predetermined rules.

In exemplary embodiments, the receiving the second media content item includes receiving a web page that is displayed on the client device, the web page including a voting option associated with the second media content item, and the input for the second media content item is a selection of the voting option.

In exemplary embodiments, the first set of predetermined rules specifies a number of remaining votes, and the selection of the voting option is prohibited upon determination that the number of remaining votes is zero.

In exemplary embodiments, the number of remaining votes is decremented upon determination that the number of remaining votes is greater than zero and the voting option is selected.

In exemplary embodiments, the number of remaining votes is incremented upon submission of the first media content item or submission of a completed survey provided by the second user.

In exemplary embodiments, the second set of predetermined rules specify that the reward for the first media content item is received upon determination that, at an expiration of a predetermined period of time, a vote total associated with the first media content item is higher than a vote total of at least a third media content item.

In exemplary embodiments, the media content item and the third media content item belong to a same predetermined category.

In exemplary embodiments, the first and second media content items are one of a picture, video, or audio file.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 is a flow chart illustrating the steps of a method for introducing gainful competition to electronic media items in accordance with an embodiment of the present invention.

FIG. 2 is a flow chart illustrating the steps of a method for providing a sense of economy to a website introducing gainful competition to electronic media items in accordance with an embodiment of the present invention.

FIG. 3 is a flow chart illustrating the steps of a method for ranking electronic content in accordance with an embodiment of the present invention.

FIG. 4 illustrates an exemplary architecture for a system in accordance with an embodiment of the present invention.

FIG. 5 is a functional block diagram of the architecture for a system in accordance with an embodiment of the present invention.

FIG. 6 is a functional block diagram of the architecture for a system in accordance with an embodiment of the present invention.

FIG. 7 is a functional block diagram of the architecture for a system in accordance with an embodiment of the present invention.

FIG. 8 is a functional block diagram of the architecture for a system in accordance with an embodiment of the present invention.

FIG. 9 is an image of an exemplary screen of a homepage in accordance with embodiments of the present invention.

FIG. 10 is an image of an exemplary screen of a registration page in accordance with embodiments of the present invention.

FIG. 11 is an image of an exemplary screen of a video submission page in accordance with embodiments of the present invention.

FIG. 12 is an image of an exemplary screen of a plurality of electronic media items in accordance with embodiments of the present invention.

FIG. 13 is an image of an exemplary screen of a single electronic media item in accordance with embodiments of the present invention.

FIG. 14 is an image of an exemplary screen of a voting page in accordance with embodiments of the present invention.

FIG. 15 is an image of an exemplary screen of a page providing the winners in several themes in accordance with embodiments of the present invention.

### DETAILED DESCRIPTION

According to an embodiment of the present invention, a system, method and computer program product for a website is provided, enabling users to compete by sharing electronic media items, voting on electronic media items, and achieving a ranking based on the completion of certain pre-selected criteria for competition. The website provides fair and balanced means of judging content (quantitatively and/or qualitatively), archiving content and winners, offering incentives and more.

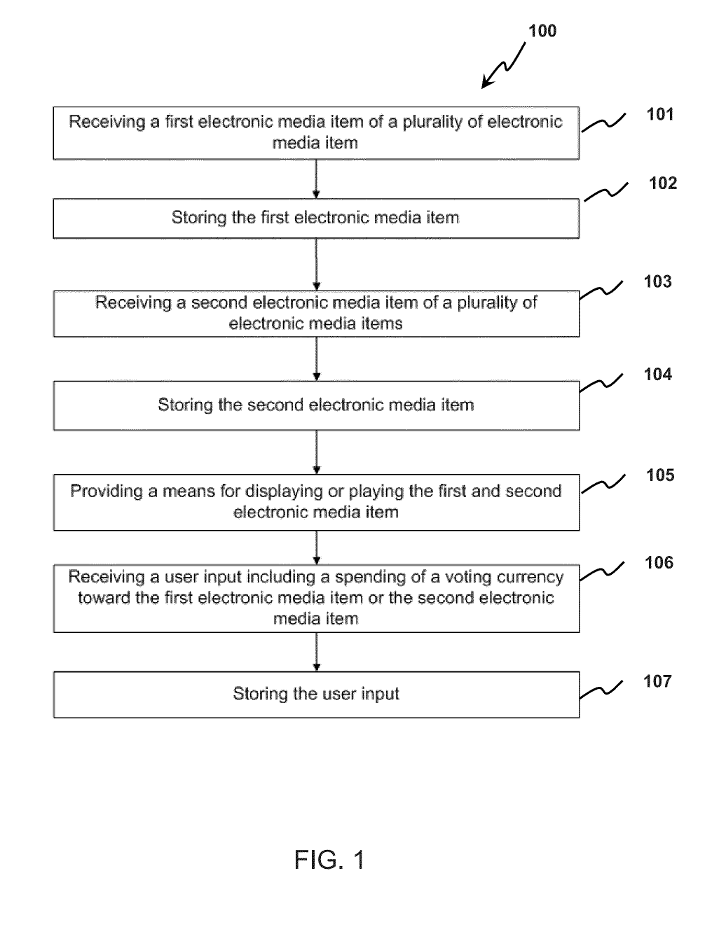

FIG. 1 is a flow chart illustrating the steps in a method for introducing gainful competition to electronic media items in accordance with an embodiment of the present invention. In an embodiment of the present invention, method 100 begins by receiving a first electronic media item of a plurality of electronic media items (step 101). Examples of electronic media items include, but are not limited to, videos, pictures, songs, other recordings, various forms of literature, etc. The electronic media item can be user-created or user-submitted. Alternatively, the electronic media item does not need to be user-created or user-submitted.

After receiving the first electronic media item, the electronic media item is stored (step 102). The electronic media item can be stored in various manners as would be understood by one of ordinary skill in the art. The electronic media item can be stored in a manner such that the content is searchable.

Next, a second electronic media item of the plurality of electronic media contents is received (step 103). The second electronic media content can be related to the first electronic media item. For example, the first and second electronic media content can have a common category or theme.

The theme or category can strive to appeal to the widest range of demographics, in terms of race, creed, region, sexuality, etc. Examples of themes include animal pictures, political spoofs, music videos, “first time” themed videos, sports videos, Halloween costumes, amateur fight videos, college experience videos, rodeo videos, boxing videos, extreme stunt videos, skateboarding videos, wedding proposal videos, racing videos, video game footage or montages, pick-up attempts, baby pictures, baby videos, most funny videos, dancer videos, fishing pictures, car modifications, motorcycle pictures, stunt videos, use of $100 pictures, finger paintings by a child, articles, fashion blogs, sports blogs, political articles, short stories, songs, speeches, motivational recordings, sermons, spoken word pieces, advice, etc. The theme can change periodically and be determined by a variety of means. The theme can be determined by a public vote, the popularity or success of a past theme, or the relation to a current event.

After receiving the second electronic media item, the electronic media item is stored (step 104). The electronic media item can be stored in various manners as would be understood by one of ordinary skill in the art. The electronic media item can be stored in a manner such that the content is searchable.

The next step in the method is providing a means for displaying or playing the first and second electronic media items (step 105). The means for displaying or playing the electronic media items can take on various forms as would be understood by one of ordinary skill in the art. As an example, if the electronic media item is a picture or video, the item can be displayed through on the screen of a client device. Alternatively, if the electronic media item is an audio recording, the item can be played through the speakers of a client device. The electronic media item can also be displayed with other related information. For example, the electronic media item can be displayed with the number of views of the item, user comments, user ratings, the number of votes (as will be explained in greater detail below), etc.

Next, a user input including a vote for the first electronic media item or the second electronic media item is received (step 106). One of ordinary skill in the art would understand that the user input can be received in various forms.

Finally, the user input including a vote for the first electronic media item or the second electronic media item is stored. As in step 102 and 104, the user input can be stored in various forms as would be understood by one of ordinary skill in the art. The user input can be stored in the same manner or in a different manner than the first and second electronic media item.

According to an embodiment of the present invention, the user input can be used to determine a winner of the competition. The present invention is intended to be gainful in a tangible sense as competitions can offer real value to winners, such as money, trophies, prizes, and other rewards. The website can also be gainful in other ways such as offering large scale exposure, possibilities of winning, entertainment, networking, and more.

According to another embodiment of the present invention, an economy or sense of an economy is provided. By “economy” or “sense of economy,” it is denoted that a form of currency or value will be in effect as a significant and intentionally distinctive quality of the operation culture, and overall experience of the present invention.

According to one embodiment of the present invention, the promotion of an economy or sense of economy is performed by the collection and earning of votes. By allowing users to collect and earn votes, a system of resource management is promoted. Votes become “voting currency”, or a unit of value, which can be generated, amassed, and spent.

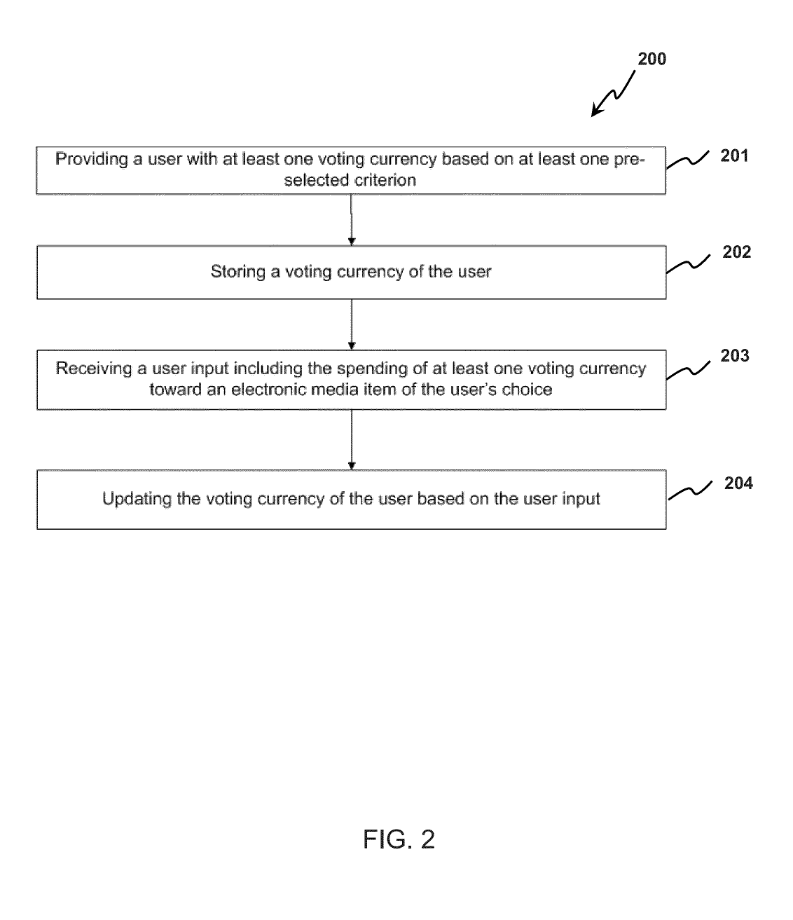

FIG. 2 is a flow chart illustrating the steps in a method for providing a sense of economy to a website introducing gainful competition to electronic content in accordance with an embodiment of the present invention. In an embodiment of the present invention, method 200 includes providing a user with at least one voting currency based on at least one pre-selected criterion (step 201).

Manners of accumulating voting currency, votes, or “wealth” generation can be varied and changing. Exemplary pre-selected criteria include completing surveys and questionnaires, submitting content to the website, having a certain number or quality of viewership of submitted content to the website. Additionally, or alternatively, voting currency can be generated and amassed at various time increments. Users can collect a certain amount of voting currency weekly, monthly, or yearly.

Next, the voting currency of the user is stored (step 202). The voting currency can be stored in various manners as would be understood by one of ordinary skill in the art.

Next, a user input is received including the spending of voting currency toward an electronic media content of the viewer's choice (step 203). When a user elects to spend voting currency, he/she is placing a vote (represented by the voting currency) toward an electronic media item. The electronic media item can be the electronic media item received and displayed as described in method 200. One of ordinary skill in the art would understand that the user input can be received in various forms. The method can provide for a user to spend only one voting currency at a time. Alternatively, the method can allow a user to spend multiple voting currencies at one time.

Finally, the voting currency of the user is updated based on the user input (step 204). The update can include calculating the voting currency of the user based on how much voting currency was “spent” by the user on the selection of an electronic media content. The update can be performed in many ways as would be understood by one of ordinary skill in the art.

According to another embodiment of the present invention, a novel developmental ranking system can complement the economic structure. The developmental ranking system can track long-term progression, certain prestige advantages, and economic advantages. The developmental ranking system can take a combination of various inputs into consideration.

The economic system and ranking system operate together to promote an overarching and dynamic system and/or sense of value. Through this synergy of competition, value acquisition, and entertainment, user participation will increase. Further, it is important to recognize that value acquisition is ideally both intangible (votes, rank, etc.) and tangible (trophies, real monies, and other physical prizes).

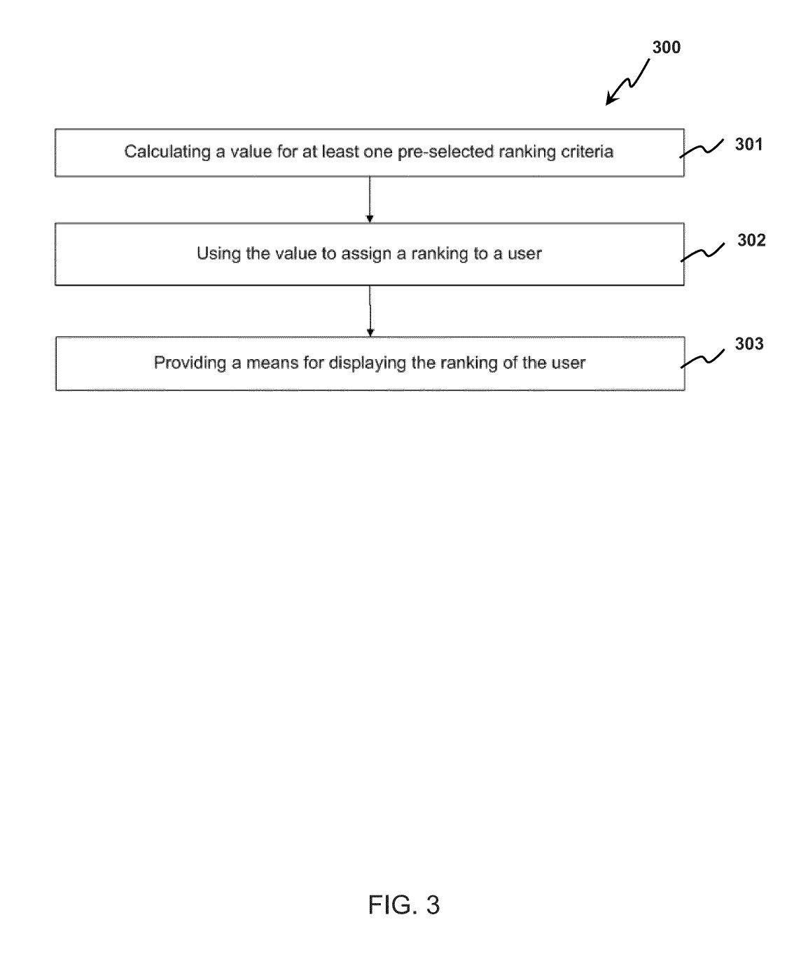

FIG. 3 is a flow chart illustrating the steps in a method for ranking a user according to an embodiment of the present invention. In an embodiment of the present invention, method 300 includes calculating a value for at least one pre-selected ranking criteria (step 301). Examples of pre-selected ranking criteria include viewership, website interaction, submission frequency, and community evaluation.

Next, the value is used to assign a ranking to a user (step 302). The ranking can be determined based on any number of combinations of the exemplary pre-selected criteria discussed above. The ranking can place equal weight on each pre-selected criteria or can place greater weight on certain pre-selected criteria and lesser weight on other pre-selected criteria. Alternatively, the ranking can be based on simply one pre-selected criteria.

Finally, a means for displaying the ranking of the user is provided (step 303). A user's rank can be displayed through the website in various manners. Exemplary forms of display include numerical, visual, emblematic representation and other displays. Additionally, the ranking can be displayed as a title or name. Examples of titles or names include Viral King, Viral Queen, Web God, Top Dog, or Vieral (i.e., a combination of the word “vie” and the word “viral”).

Beyond the economic and ranking system, applicable forms of social media can be implemented to further enhance the interactive platform of this website. An environment of sharing will be fostered, and the system, method and computer program product of the present invention will provide concurrent capacities for competition and gain.

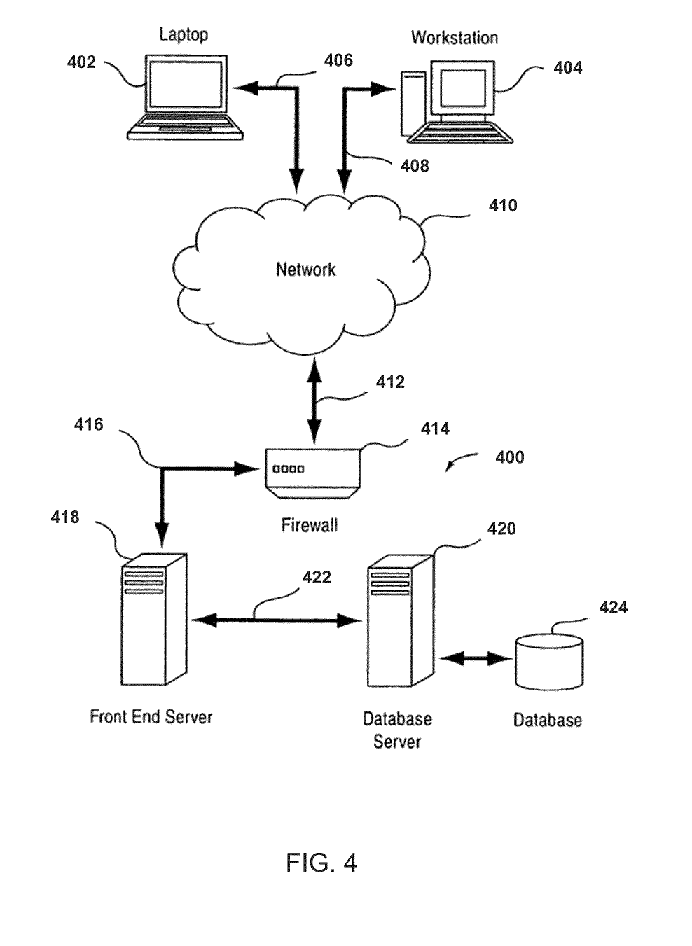

FIG. 4 is a diagram of an exemplary architecture for a system in accordance with an embodiment of the present invention. Laptop 402 and workstation 404 are personal computers (PC) connected to network 410 through networks 406 and 408, respectively. Networks 406 and 408 may be wired or wireless networks, private or public networks, local or wide area networks, virtual networks, etc., or any combination thereof. Network 410 is, generally, a wide area public network, such as, for example, the Internet. Typically, laptop 402 and workstation 404 access the Internet through respective Internet Service Providers (ISPs) (not shown). Other embodiments of network 410 include wired or wireless networks, private or public networks, local or wide area networks, virtual networks, etc.

Front end server 418 is connected to network 410 directly (not shown) or through firewall 414, and to database server 420 through network 422. Front end server 418 and database server 420 may be custom-built servers, industry standard servers, such as, for example, HP ProLiant servers, etc. Front end server 418 executes software implementing various features of the present invention, while database server 420 can store and manage information relating to the display of the application as well as information relating to user-generated electronic media items and the dynamic voting and ranking. For example, Microsoft's .NET, Windows Server and SQL Server software packages may be deployed on these machines. In an alternative embodiment, front end server 418 also functions as database server 420, i.e., a single server may be employed.

Embodiments of networks 412, 416 and 422 include wired or wireless networks, local or wide area networks, virtual networks, etc., or any combination thereof. Network 412 is a public network, connecting firewall 414 to network 410, while networks 416 and 422 are private networks. While database server 420 is depicted as being connected to front end server 418 via network 422, networks 416 and 422 may also be a single network. Accordingly, one embodiment of the present invention includes a single server connected directly to the Internet.

The website, system, and method of the present invention can be implemented using any operating system, and associated hardware including, but not limited to, Unix, Linux, VMS, IBM, Microsoft Windows NT, 95,98, 2000, ME, XP, and 8.0, Mac OS, Palm OS, Android, Microsoft Windows CE, Microsoft Windows Mobile, Symbian OS and the like.

The system, method and computer program product providing a website set forth in the present description may be implemented using one or more general purpose computers, microprocessors, or the like programmed according to the teachings of the present specification, as will be appreciated by those skilled in the relevant art(s). Appropriate software coding can readily be prepared by skilled programmers based on the teachings of the present disclosure, as will be apparent to those skilled in the relevant art(s).

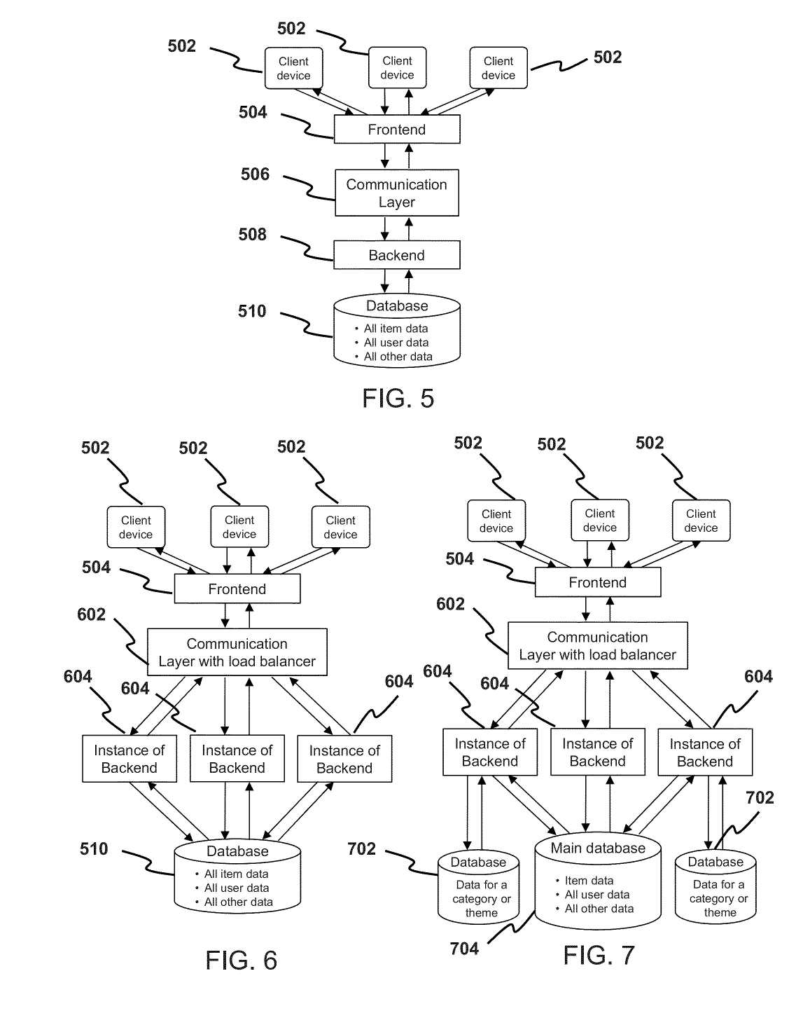

According to embodiments of the present invention and as shown in FIGS. 5-7, the platform is advantageously implemented with functionality and processing load distributing between one or more application tiers. For example, for reasons of maintenance and scalability the platform is divided into two parts (i) a system for rendering the output to the users (hereafter Frontend 504), and (ii) a system for processing of data (hereafter Backend 508). Both parts communicate via a communication layer 506 which manages the traffic and optimally distributes all requests. All data is being stored in a database 510. A plurality of client devices 502 (e.g., personal computers, smartphones, etc.) can access the system simultaneously.

Common variations include a system with multiple instances of the backend 508 which allows for parallel processing of incoming requests from a large amount of users. The management of multiple instances of backend 508 are managed using a load balancer implemented in the communication layer 506. Each backend instance 404 may connect to one or more databases.

For maximum performance a common architecture is to have a group of electronic media contents on one database 702 and having all votes related to the specific electronic media contents directed by the communication layer to the one backend 604 which will connect to the database 704 which stores them.

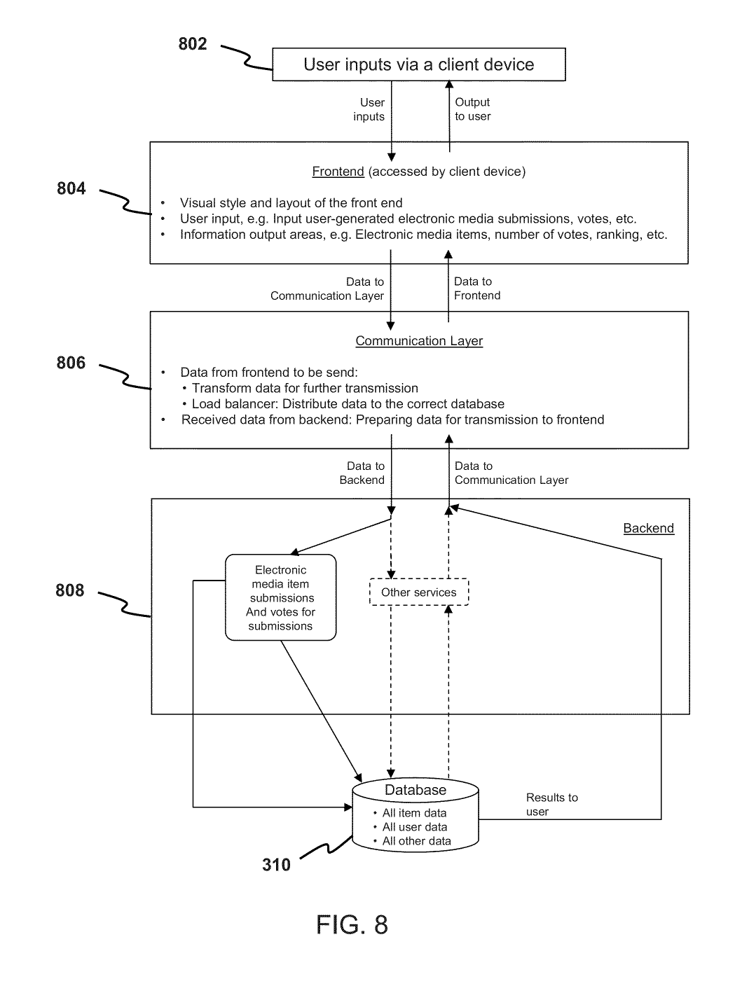

FIG. 8 is a flow diagram which shows the functionality and flow of information between the various components of the system according to an embodiment of the invention. The various system components, i.e. frontend 804, backend 808, communication layer 802, perform specific functions. The frontend 804 is rendering a presentation of the user-generated electronic media item information, vote information and other relevant information to the client device 802 of a user. It also delivers the visual style and layout for this information. Moreover, it delivers the user input controls, e.g. fields to enter a vote, as well as information output areas, e.g. numbers about current views, votes, ranking, etc. The frontend also performs validation of user inputs to prevent improper voting.

The communication layer 806 receives user data which the user entered into the user input controls of the frontend. It transforms this data for transmission to the other parts of the system, i.e. the backend and the database 808. It can also perform the required management functions for distributing requests optimally across various instances of the backend 808. When the communication layer 806 receives data from the backend it prepares it for transmission to the frontend 804 where it is further processed for display in the presentation layout.

The backend 808 consists of various components, e.g., a queue of votes for each content submission. These components work together as well as connect with the database to process incoming votes. Moreover, the backend 808 also handles other services, e.g. requests for displaying information about current content submissions, etc. Components data flows handling other services are marked with dashed lines.

The core function of the backend 808 is the processing of votes whose components and data flows are marked with solid lines. Each incoming vote is put into the queue of the associated content submission. Each queue contains votes from one content submission only and they are sorted by the first in first out principle.

### EXAMPLES

While the present invention may be embodied in many different forms, a number of illustrative embodiments are described below with the understanding that the present disclosure is to be considered as providing examples of the principles of the invention and such examples are not intended to limit the invention to the embodiments described and/or illustrated herein.

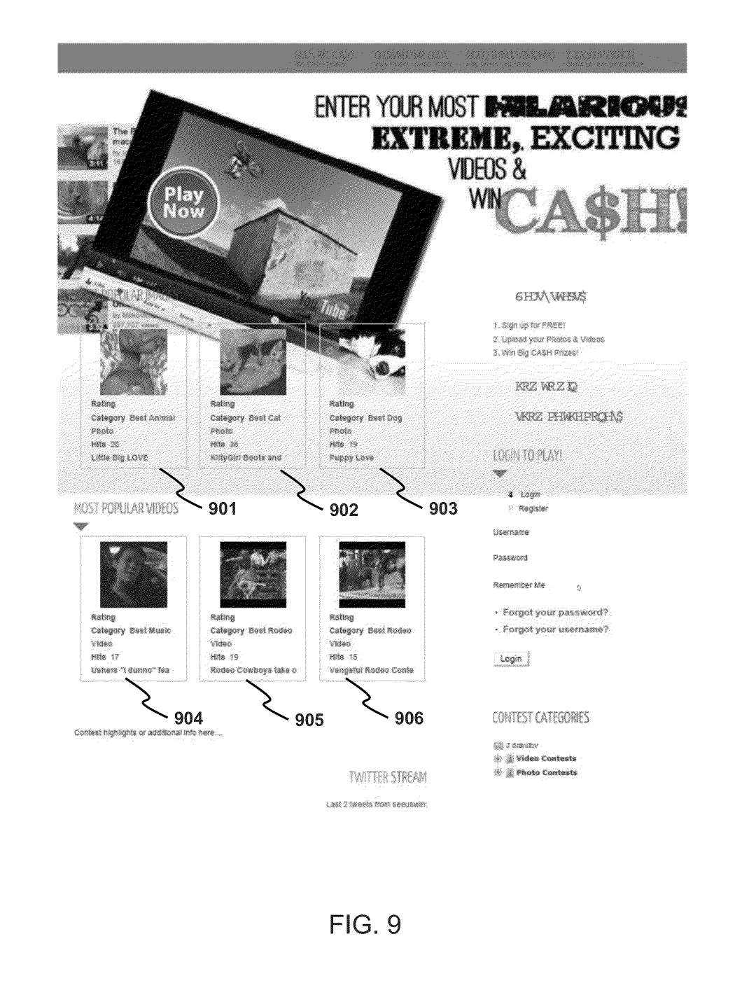

FIG. 9 is an image of an exemplary screen of a homepage in accordance with embodiments of the present invention. The electronic media items 901, 902, 903, 904, 905, 906 displayed on the homepage can be selected based on popularity. In an exemplary homepage, the most popular images 901, 902, 903 and videos 904, 905, 906 are displayed, as determined by the number of views of each electronic media item.

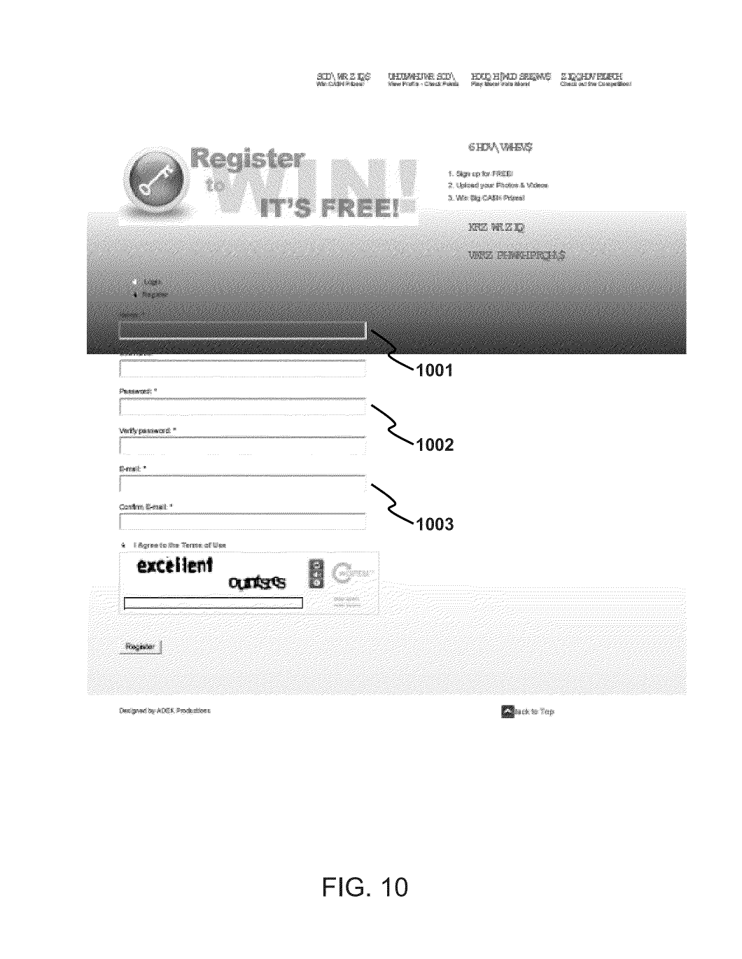

FIG. 10 is an image of an exemplary screen of a registration page in accordance with embodiments of the present invention. The registration page can allow users to register their personal information with the website administrator so that statistics for the user can be maintained. The information maintained for each user can include the amount of voting currency. The registration page can also assist with assigning a user a ranking, as described in greater detail above. In an exemplary registration page, the user is required to submit a name 1001, a password 1002, and an email address 1003.

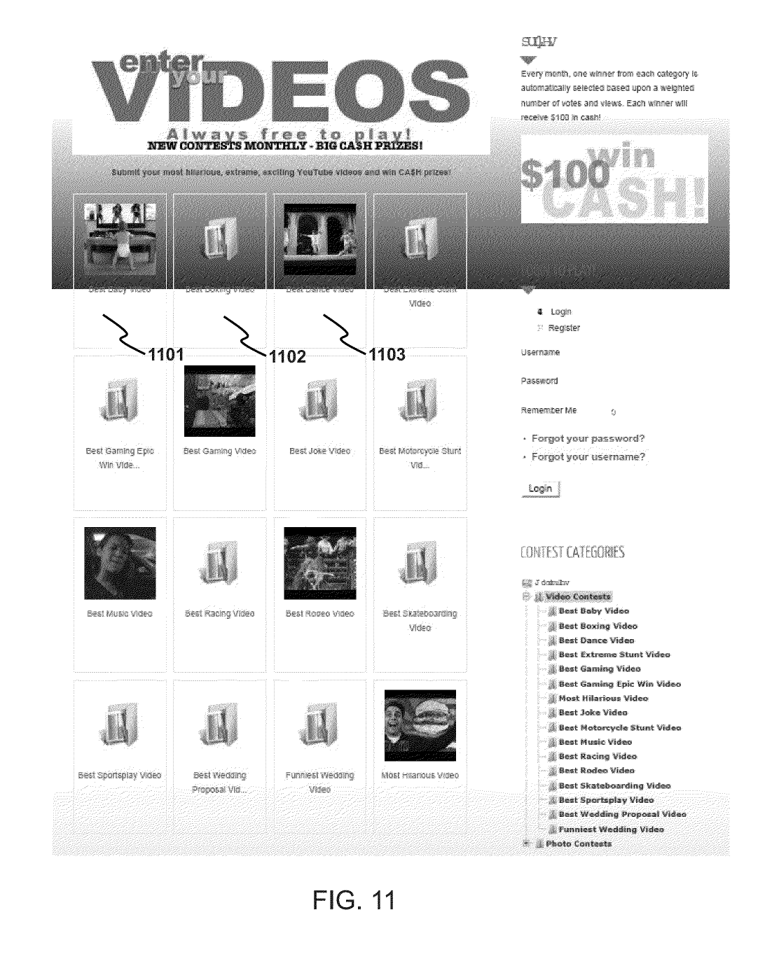

FIG. 11 is an image of an exemplary screen of a video submission page in accordance with embodiments of the present invention. A video submission page can allow a user to submit electronic media content. In an exemplary video submission page, a user can submit electronic media based on the theme or category of the electronic media items 1101, 1102, 1103.

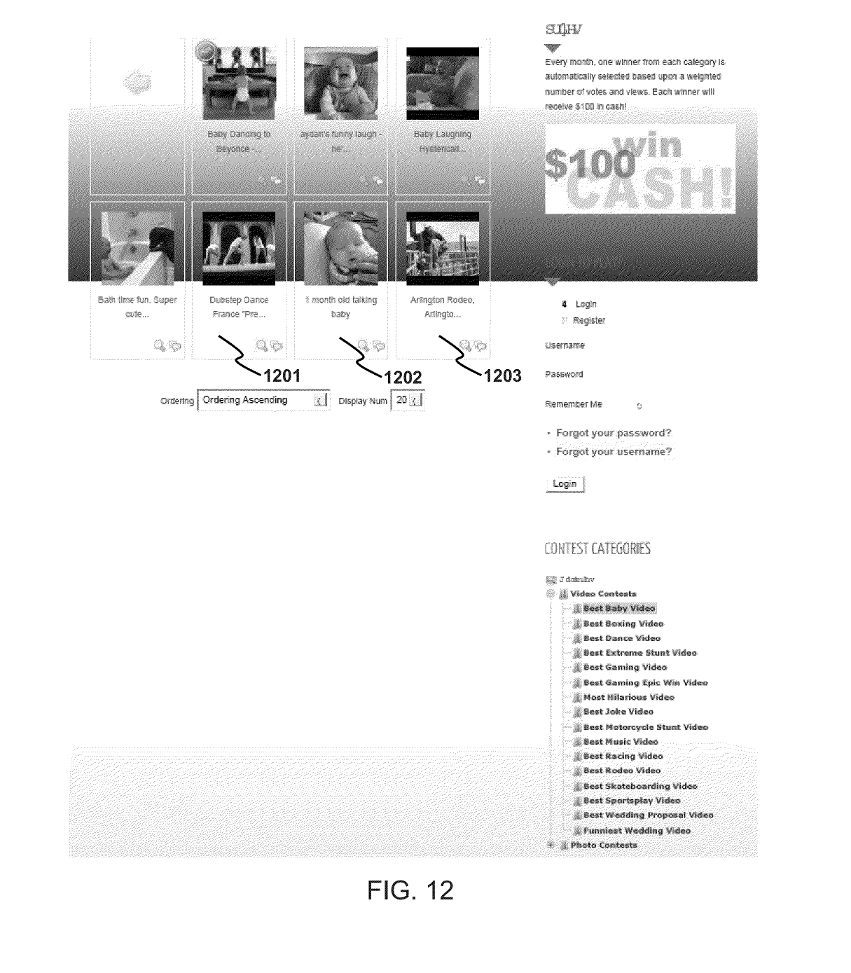

FIG. 12 is an image of an exemplary screen of a plurality of electronic media items in accordance with embodiments of the present invention. An electronic media item selection page can display the electronic media items in various formats. In an exemplary page, electronic media items 1201, 1202, 1203 can be sorted based on various criteria. The electronic media items can be sorted and displayed based on the format of the electronic media item (i.e., video, picture, audio recording, etc.). Additionally, the electronic media items can be sorted and displayed based on the theme or category.

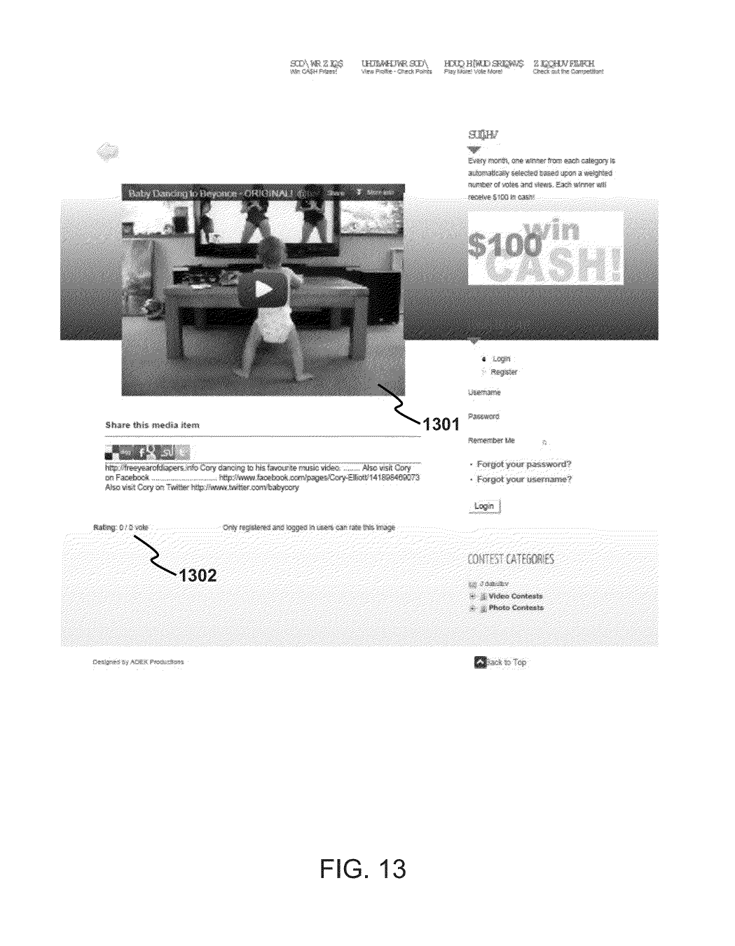

FIG. 13 is an image of an exemplary screen of a single electronic media item in accordance with embodiments of the present invention. An electronic media display page can display the electronic media item in multiple formats. In an exemplary electronic media item display page, electronic media item 1301 is displayed in the form of an embedded YouTube video. The example can also display the number of votes 1302 for an electronic media item.

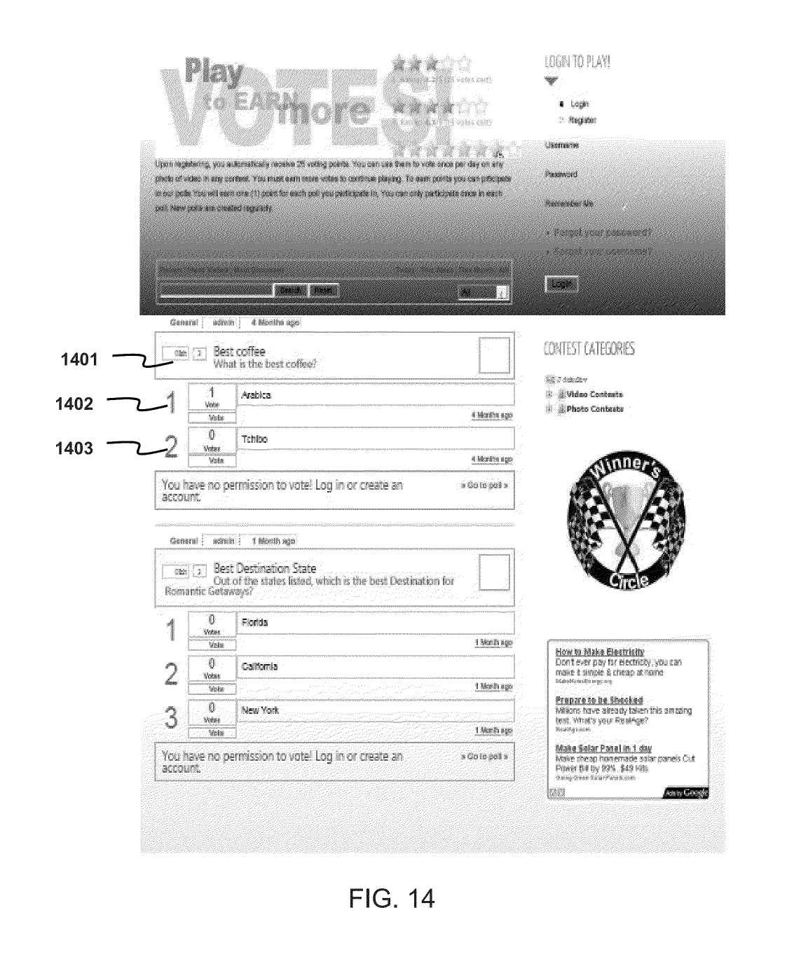

FIG. 14 is an image of an exemplary screen of a voting page in accordance with embodiments of the present invention. A voting page provides a means for a user to input a vote for a selected question, poll, or electronic media content. In an exemplary voting page, poll question 1401 is displayed with potential responses 1402 and 1403. A user can select either potential response 1402 or 1403, and by doing so casts a vote for his/her preferred selection.

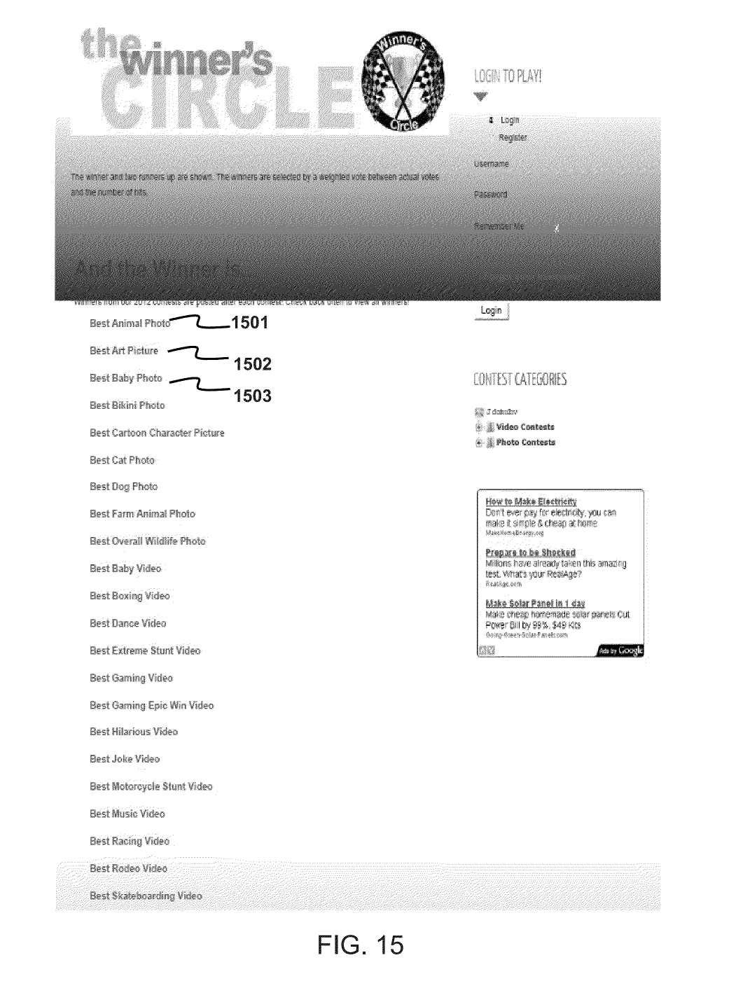

FIG. 15 is an image of an exemplary screen of a page providing the winners in several themes in accordance with embodiments of the present invention. An electronic media “winner's circle” page can display the winners of various theme-based electronic media item competitions. In an exemplary “winner's circle” page, a link to the winner of the best animal photo 1401, best art picture 1402, and best baby photo 1403 (among other theme-based competitions) is displayed. By clicking on the link, a user can access and view/play the winning electronic media item.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the methods described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

1. A method for providing rewards, the method comprising:
receiving a media content item from a first user;
providing the media content item to a second user;
receiving input from the second user in accordance with a first set of predetermined rules associated with the second user; and
providing a reward to the first user in accordance with a second set of predetermined rules associated with the media content item.

2. The method according to claim 1, wherein
the providing the media content item to the second user includes providing a web page that is displayed on a client device of the second user, the web page including a voting option associated with the media content item, and
the input from the second user is a selection of the voting option.

3. The method according to claim 2, wherein the first set of predetermined rules indicates that the second user has a number of remaining votes, and the selection of the voting option by the second user is prohibited upon determination that the number of remaining votes is zero.

4. The method according to claim 3, further comprising:
decrementing the number of remaining votes of the second user upon determination that the number of remaining votes is greater than zero and the second user selected the voting option.

5. The method according to claim 3, further comprising:
incrementing the number of remaining votes of the second user by a predetermined amount upon determination that one or more media content items or a completed survey was received from the second user.

6. The method according to claim 2, further comprising:
incrementing a vote total associated with the media content upon selection of the voting option by the second user.

7. The method according to claim 5, wherein the second set of predetermined rules specify that the first user is provided the reward upon determination that, at an expiration of a predetermined period of time, a vote total associated with the media content item is higher than a vote total of at least another media content item.

8. The method according to claim 7, wherein the media content item and the another media content item belong to a same predetermined category.

9. The method according to claim 1, wherein the media content item is one of a picture, video, or audio file.

10. A system for providing rewards, the system comprising:
one or more servers, wherein each of the one or more servers includes:
a processor,
a memory coupled to the processor, and
a network interface coupled to the processor,
wherein one or more of the processors is configured to:
receive a media content item from a first user,
provide the media content item to a second user,
receive input from the second user in accordance with a first set of predetermined rules associated with the second user, and
provide a reward to the first user in accordance with a second set of predetermined rules associated with the media content item.

11. The system according to claim 10, wherein
the one or more of the processors is further configured to provide the media content item to the second as a web page that is displayed on a client device of the second user, the web page including a voting option associated with the media content item, and
the input from the second user is a selection of the voting option.

12. The system according to claim 11, wherein the first set of predetermined rules indicates that the second user has a number of remaining votes, and the one or more of the processors is further configured to prohibit the selection of the voting option by the second user upon determination that the number of remaining votes is zero.

13. The system according to claim 12, wherein the one or more of the processors is further configured to decrement the number of remaining votes of the second user upon determination that the number of remaining votes is greater than zero and the second user selected the voting option.

14. The system according to claim 12, wherein the one or more of the processors is further configured to increment the number of remaining votes of the second user by a predetermined amount upon determination that one or more media content or a completed survey was received form the second user.

15. The system according to claim 11, wherein the one or more of the processors is further configured to increment a vote total associated with the media content upon selection of the voting option by the second user.

16. The system according to claim 14, wherein the second set of predetermined rules specify that the first user is provided the reward upon determination that, at an expiration of a predetermined period of time, a vote total associated with the media content item is higher than a vote total of at least another media content item.

17. The system according to claim 16, wherein the media content item and the another media content item belong to a same predetermined category.

18. The system according to claim 10, wherein the media content item is one of a picture, video, or audio file.

19. A non-transitory computer readable medium having instructions stored therein, which when executed by a processor in a system for providing rewards, causes the processor to execute a method comprising:
receiving a media content item from a first user;
providing the media content item to a second user;
receiving input from the second user in accordance with a first set of predetermined rules associated with the second user; and
providing a reward to the first user in accordance with a second set of predetermined rules associated with the media content item.

20. The non-transitory computer readable medium according to claim 19, wherein
the providing the media content item to the second user includes providing a web page that is displayed on a client device of the second user, the web page including a voting option associated with the media content item, and
the input from the second user is a selection of the voting option.
